(19) United States
(12) Patent Application Publication
(10) Pub. No.: US 2026/0368251 A1
(43) Pub. Date: Nov. 19, 2026

(54) Data Management Using Cascading Hashes And/Or Image Embeddings

(71) Applicant: Oracle International Corporation, Redwood Shores, CA (US)

(72) Inventors: Amit Agarwal, Seattle, WA (US); Hussain Bohra, Chicago, IL (US); Priyaranjan Pattnayak, Snohomish, WA (US)

(73) Assignee: Oracle International Corporation, Redwood Shores, CA (US)

(21) Appl. No.: 19/207,752

(22) Filed: May 14, 2025

(51) Int. Cl. G06F 16/901; G06F 16/955

(52) U.S. Cl. CPC G06F 16/9014; G06F 16/9566

(57) ABSTRACT

Techniques for data ingestion using a cascading hash are disclosed. A data ingestion and management system ingests data such as a snapshot. For data having a hierarchical structure, the system generates hashes for different levels of the data hierarchy. The system compares the hashes of stored data with hashes of incoming data. The system does not update stored data with new data for parts of the data hierarchy for which the hashes match. For parts of the data hierarchy where the hashes differ, the system checks the hashes at the next lower level of the hierarchy until the hashes for individual data items are checked. The hashes are stored in a hash table with identifiers for the data hierarchy and data items. The identifiers indicate a type of a data item, so that data items with different hashes are selectively updated based on the type of the data.

### TECHNICAL FIELD

The present disclosure relates to systems for data ingestion, management, and/or monitoring.

### BACKGROUND

Data management systems expend a great deal of time and resources ingesting data into databases where the data is stored. Some strategies used by data management systems to extract, transform, and load data into databases include incremental ingestion and snapshot ingestion. Incremental ingestion, also referred to as data update, captures only the new or updated data since a previous ingestion or snapshot was performed. Snapshot ingestion captures an entire data set at once, creating a complete snapshot of the data at a specific point in time. Incremental ingestion is generally more efficient and suitable for continuous data streams, reducing redundant data processing operations. However, it requires determining what data has changed between two snapshots or data updates, which can be a challenging task. Snapshots are often very large, spanning several folders, files, and datatypes. Ingesting the data by comparing every document in a snapshot against documents in an existing database is time-consuming and resource-intensive. Tracking what data has changed since a previous update may also be difficult. Often, a change to a document in a snapshot is not substantive in terms of the semantic content of the document, yet the document is processed anyway. Traditional methods of comparing incoming data to existing database data are inefficient.

Techniques in this disclosure may address the aforementioned flaws, challenges, and difficulties. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example data management system using cascading hashes and/or image embeddings, in accordance with one or more embodiments;

FIG. 2A-B illustrate example operations for data ingestion, management, and/or monitoring, in accordance with one or more embodiments;

FIG. 3A-D illustrate example data ingestion, data management, data monitoring, and metric collection and visualization techniques using cascading hashes and/or image embeddings, in accordance with one or more embodiments;

FIG. 4 illustrates an example machine learning engine in accordance with one or more embodiments;

FIG. 5 illustrates example operations for machine learning in accordance with one or more embodiments; and

FIG. 6 illustrates a block diagram of a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE DATA MANAGEMENT SYSTEM USING CASCADING HASH AND/OR IMAGE EMBEDDING
3. EXAMPLE OPERATIONS FOR DATA MANAGEMENT USING CASCADING HASH AND/OR IMAGE EMBEDDING
4. EXAMPLE DATA MANAGEMENT TECHNIQUES USING CASCADING HASH AND/OR IMAGE EMBEDDING TABLE(S)
4.1 Example Data Ingestion and Hash Table Creation
4.2 Example Data Ingestion and Hash Table Comparison
4.3 Example HTML Document Chunking and Chunk Identification
4.4 Example Document Monitoring and Metric Visualization
5. MACHINE LEARNING ARCHITECTURE
6. MACHINE LEARNING OPERATIONS
7. GENERATIVE ARTIFICIAL INTELLIGENCE MODELS
8. COMPUTER NETWORKS AND CLOUD NETWORKS
9. MICROSERVICE APPLICATIONS
10. HARDWARE OVERVIEW
11. MISCELLANEOUS; EXTENSIONS

### 1. General Overview

While this General Overview section provides a general overview, additional embodiments and related combinations of features may be described in this Specification and/or recited in the claims outside of this General Overview section.

Database performance is critical to downstream applications and data pipelines. Slowdowns in a data update or snapshot ingestion process can lead to cascading issues downstream. Efficient and comprehensive data management solutions help address such bottlenecks and/or other database performance problems.

Some platforms use inverted indexes to make data ingestion more efficient. An inverted index is a data structure that maps words to their locations in documents instead of storing documents sequentially. An example platform that uses inverted indexes is OpenSearch, which is an open-source suite of technologies that provide a distributed search engine, real-time data analytics, and visualization tools to enhance the data ingestion process. Inverted indexes make lookups and comparisons much faster during data updates. Instead of scanning all documents, a data ingestion system may retrieve results directly from the index by looking up a word in the index and retrieving only the matching documents. However, even using an inverted index, comparing an entire snapshot of data against a such an index for a large data set is inefficient, requiring a significant number of lookups and document retrievals.

Moreover, even for a selection of just some of the data, simple document comparisons are also inefficient. For example, stylistic changes to components of documents, such as changes to the Cascading Style Sheet (CSS) definition or other formatting definition, occur often that do not change a document's core content, semantic meaning, or substantive body. In embodiments where the substantive body (e.g., the content-related text corpus) of a document undergoes semantic processing triggering processing for superficial changes to formatting wastes resources.

Another challenge with data updates and snapshot ingestion is the increasingly multimodal nature of data processing. Inverted indexes are designed to search for word locations within documents. However, the system may need to check for updates to images, videos, and/or data of other modalities.

One or more embodiments provide techniques for data management, ingestion, and/or monitoring. Embodiments include a data management system that employs a unique identification mapping technique alongside a change tracking mechanism to efficiently handle document indexing. A document that is ingested is chunked. The chunks and document, and the corresponding file, folder, directory, and/or artifact in which the document resides are assigned a unique identifier. In some cases, a unique identifier is based on a uniform resource locator (URL) of the document. Data management systems periodically ingest snapshots of the system that include changes to some documents and no changes to other documents. When new documents are loaded, the system compares their identifiers with identifiers that are already indexed by using set operations to identify new documents and to determine if a new ingested document is associated with an existing document. Often, the documents arrive as a part of a snapshot, with no clear indication of whether the documents have been newly created, edited, or deleted since the previous snapshot. This lack of version tracking creates a significant challenge in ensuring that all instances of data match.

Embodiments of data management systems disclosed herein deploy a hash table that is referenced during data ingestion to determine if cascading components of the data being ingested have been changed. For example, if the hash for an artifact is changed, the system compares hashes for data items at a next data layer. For a data item of data set that is being ingested, the system determines if a hash of that data item matches the hash for a corresponding data item (having a matching identifier in the hash table). If the hashes do not match, the system proceeds to compare hashes at the next data layer. If the hashes do match, the system proceeds to compare the next hash at the current data layer. For example, if a hash for an ingested data folder does not match the hash for a stored data folder, the system compares hashes for files in the folder. If the hashes do match, the system proceeds to the next folder. If the hash for an ingested file does not match a hash for a stored file, the system proceeds to compare hashes for documents in the file, and so forth. Different data hierarchies have various numbers of layers and are not limited by to a particular number of data layers.

Regardless of the number of layers or size of a data artifact, hash tables efficiently track and update documents in an index, such as an OpenSearch index. This mechanism optimizes the creation, deletion, and update process by ensuring modified documents are processed and unmodified documents are not processed, reducing redundant operations. Further, the system uses separate hashes for chunks of documents that are content-related and chunks of documents that relate to formatting or superficial stylistic changes, such as cascading style sheets (CSS) or hypertext markup language (HTML) formatting, so that unnecessary updates to non-content related components of documents are avoided.

Instead of comparing every document in the snapshot, the data management engine utilizes a cascading hashing mechanism that focuses only on documents within folders that have changed. This significantly reduces the time and resources required to process incoming documents, as it eliminates unnecessary comparisons. Embodiments of the engine track changes at the image level. By comparing image embeddings, the system is able to detect image modifications within documents that are ignored by traditional systems. This enhancement enables the system to manage data for multiple modalities and to support applications that require text, image, and/or other media types.

Also, the data management system tracks metrics at various data layer levels. The system collects metrics at a folder level, a file level, a service level, a document level, a document chunk level, and/or another data layer. The data management engine deploys one or more hierarchical hash tables, with hierarchical layers of the hash table(s) corresponding to the data layers of a data artifact. The hash table(s) includes unique key identifiers across different the different levels (i.e., artifacts, folders, files, chunks, etc.).

Larger source documents are divided into multiple smaller documents or document chunks. The system breaks the documents apart by subsections or headers into different document chunks. The system uses semantic based splitting to further sub-divide sections or sub-sections into smaller coherent chunks. For example, the system breaks up documents so that chunks include a single topic. As documents and chunks are indexed, unique key identifiers (e.g., URLs) for the documents and chunks are stored in a hash table. Upon receiving a new data artifact, unique key identifiers for the new data artifact are compared with the keys stored in the hash table.

By comparing the keys, the system determines which documents in the new artifact already exist in an index (e.g., an inverted index) and which documents are new or have been modified since the last update. New or changed documents and/or chunks are processed by topic extraction, key-phrase extraction and/or summary generation models. Documents and/or chunks that have not been changed are not semantically processed in this way. Performing semantic processing selectively in this way reduces computation cost associated with ingesting the new artifact drastically.

The system is configured to generate metrics at different stages to monitor the journey of documents from creation, through updates, until the document is retired. For example, the metrics track the number of changes or edits in a document, the volume of change as percentage of words and/or sentences being changed, the number of document chunks being changed, the number of documents for which edits have been requested, the number of changes for a topic, the number of changes to generated summaries and/or extracted key-phrases, and so forth. Topical metadata helps the system track data drift patterns. Metadata added to document chunks also help clustering algorithms to auto-suggest indices. Documents or services having content that is frequently changed are flagged by the system to identify data at risk of having stale content or lower quality content. Customer feedback from search systems and/or chat bot systems are also incorporated into the documents via different teams. Tracking the effect of the changes to weight future changes improves customer experience for customers using the chat bot systems.

### 2. Example Data Management System Using Cascading Hash and Image Embedding

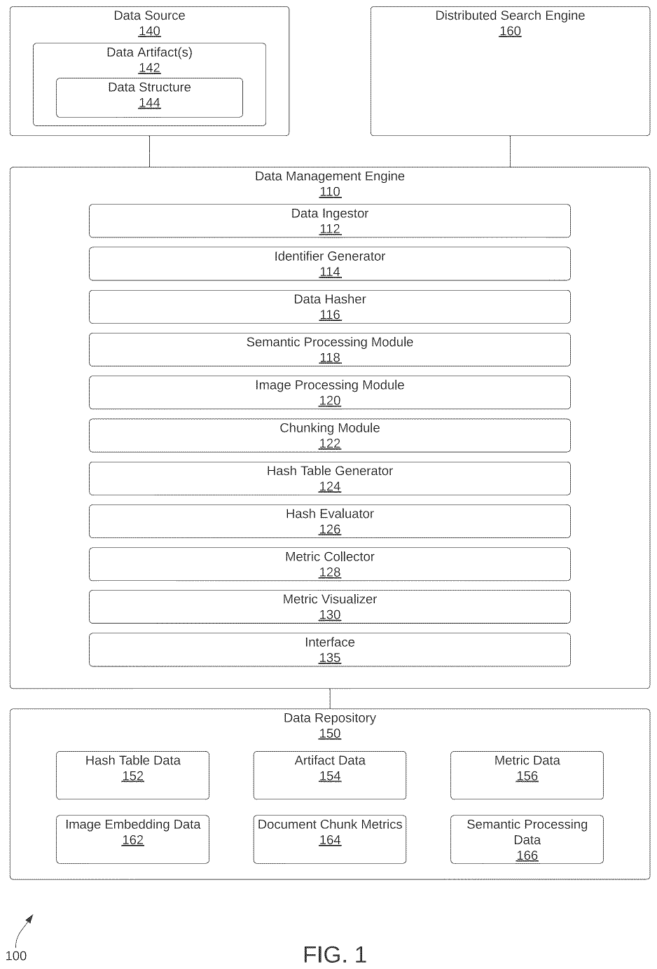

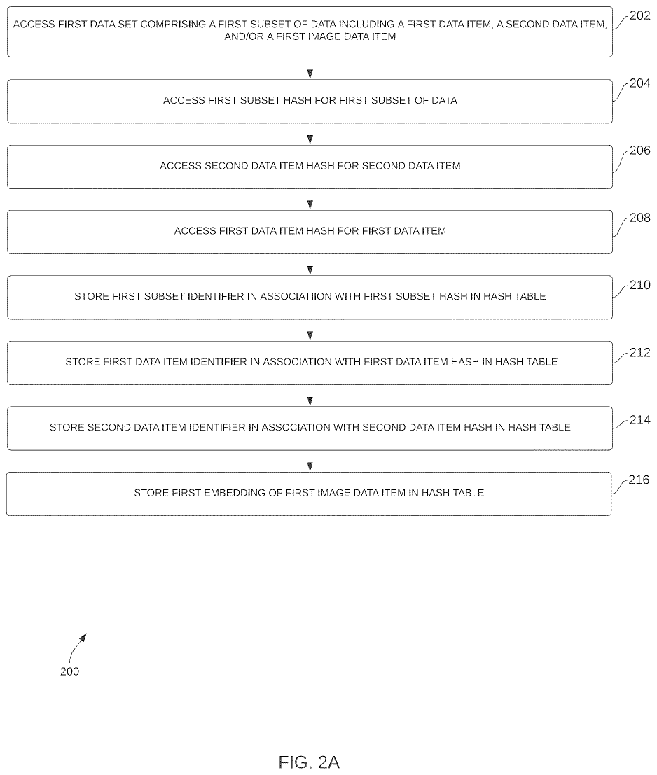

FIG. 1 illustrates an example data management system 100. In FIG. 1, the data management system 100 includes a data management engine 110, one or more data sources 140, a data repository 150, and a distributed search engine 160. For example, the data management engine 110 is configured for ingesting, managing, storing and/or monitoring data.

As shown, the data management engine 110 comprises a data ingestor 112, an identifier generator 114, a data hasher 116, a semantic processing module 118, an image processing module 120, a chunking module 122, a hash table generator 124, a hash evaluator 126, a metric collector 128, a metric visualizer 130, and an interface 135.

In FIG. 1, the data ingestor 112 refers to a tool for importing, processing, and/or loading data from a data source. Different kinds of data ingestion include batch data ingestion or continuous-stream data ingestion. Batch ingestion involves processing, loading and/or transmitting a discrete amount of data in intervals or batches. Continuous-stream ingestion refers to processing, loading and/or transmitting a data flow on an on-going basis. In some embodiments, the data ingestor 112 is configured to ingest data snapshots.

A data snapshot is a static capture of a dataset at a specific point in time, preserving its state for reference, analysis, or backup. It allows for historical comparisons, auditing, and rollback capabilities without modifying the live data. Ingesting a snapshot involves loading it into a system or database. In some cases, the data ingestor 112 performs data validation, preprocessing, transformation, and/or indexing as the data is ingested.

The identifier generator 114 is a component that creates unique identifiers for data artifacts, data folders, data files, documents, and/or document chunks. For documents whose location is given by a universal resource locator (URL), the identifier generator 114 generates a identifiers that are based on the URL for the document and other attributes of chunks of the document. For example, the identifier generator 114 includes functions or algorithms that identify a URL for a document that is part of a data set. The functions or algorithms generate unique identifiers for chunks of the document by appending information such as chunk number or chunk type to the URL to generate the unique identifiers.

The data hasher 116 includes modules that transform input data into a hash value. The data hasher 116 includes a hash function module that implements algorithms such as SHA-256 (or another secure hash algorithm), MD5 (or other message-digest algorithm), or Blake 2, or another algorithm, to convert a document chunk into a hash value. A hash value is a typically fixed-length string of characters generated by applying a hash function to input data, such as text, files, or the like. Hash values act as a fingerprint for the input. Hash values are typically unique and are used to determine if two items match by comparing hash values for the items produced by a same algorithm.

The semantic processing module 118 includes various components for processing semantic content of document chunks. The semantic processing module 118 includes components that process the text of document chunks to determine topics, key-words, key-phrases, and/or other attributes of the text that is being processed. In various embodiments, the semantic processing module includes a trained language model, a tokenizer, a syntax parses, an entity recognizer, a semantic encoder, a semantic decoder, a context analyzer, and/or the like. For example, the semantic processing module 118 converts text to and from vector representations such as word2vec or BERT-based embeddings. Using these components, the semantic processing module 118 generates summaries or key-words and/or identifies a topic, theme, tone, date, or other attribute of the document chunk.

The image processing module 120 includes various functions, algorithms, and/or models that generate encodings from images and/or that that analyze images to detect objects in, enhance, or compress the images. In embodiments, the image processing module 120 includes an image formatting model that normalizes, resizes, or converts an image to a standard format. In various embodiments, the image processing module 120 includes functions and/or models that perform feature extraction, compression, or optical character recognition.

In embodiments, the image processing module 120 comprises a Base64 encoder. Base64 encoders for images converts binary image data into a text-based Base64 string. This encoding process allows images to be embedded directly in text-based formats, such as HTML, cascading style sheets (CSS), JavaScript object notation (JSON), or extensible markup language (XML), without requiring separate file storage. The encoded string consists of ASCII characters, making it safe for transmission over text-based protocols (e.g., email, application programming interfaces [APIs]). In other embodiments, the image processing module 120 comprises an encoder selected from: a hexadecimal encoder, an ASCII85 encoder, a multipurpose internet mail extension (MIME) encoder, a blob URL (or object-URL) encoder, a binary serializer, and/or the like.

The chunking module 122 is a component that divides data into smaller, manageable parts or “chunks” for processing, transmission, or analysis. In general, chunking is the process of dividing data into smaller, manageable units, or “chunks,” to facilitate efficient processing, analysis, or retrieval. The chunking module 122 includes one or more algorithms, functions, or the like, that operate to divide the data in one or more ways using various suitable techniques. In embodiments, the chunking module 122 comprises one or more of: a segmentation engine that splits text, images, or data streams into logical sections; a size controller that determines chunk size based on defined limits; and/or an indexing system that assigns unique identifiers or numbers to chunks of a document.

In an embodiment, one or more specialized chunking techniques are applied to an HTML document. The specialized chunking techniques involve parsing the content of the HTML document then separating it based on structural or semantic elements. The chunking module 122 extracts text chunks from elements such as paragraphs, headings, list items, and blockquotes from the content. The chunking module 122 extracts image chunks by identifying image tags (e.g., <img> tags). The text and/or image chunks are named systematically using a combination of the HTML URL, a title for the HTML document, an identifier, or the like. In various embodiments, the chunk names include an index, a chunk type indicator, a chunk number, and/or another attribute of a chunk as a part of a chunk name.

The hash table generator 124 is a component that generates one or more hash tables from hashes and identifiers. For example, an identifier for a document chunk includes a URL for the document, a chunk number, and a chunk type descriptor. The hash table generator 124 generates hashes of artifacts, folders, files, documents, and/or document chunks and associated identifiers for the artifacts, folders, files documents, and/or document chunks, respectively. The hashes and identifiers are transmitted and stored in the data repository 150 (or another storage location). In embodiments, the hash table generator stores an identifier for an image of a document in association with an encoding of the image. For example, the hash table generator stores a URL for the document containing an image, a document chunk number, and/or a descriptor describing the document chunk as an image chunk in association with a Base64 encoding of the image contained in the image chunk.

The hash evaluator 126 is a component that compares hash values for incoming data to hash values stored in a hash table. The hash evaluator 126 identifies a hash value in hash table that has an identifier that matches an identifier for incoming data. The hash evaluator 126 compares the hash value in the hash table to a hash value for the data to determine if the hashes match. In various embodiments, a hash evaluator 126 includes a collision detector that detects if two different inputs produce a same hash; an entropy analyzer that measures the randomness of hashes; and/or a benchmarking tool that evaluates the computation time for generating and/or comparing hashes.

The metric collector 128 includes components such as a data sampling module, a logging engine, a metric aggregator, and/or a data stream monitor. The metric collector 128 includes algorithms or functions that record the number, density, or frequency of changes to a data artifact, folder, file, document, or document chunk. For example, the metric collector 128 records a count of the number of chunks of a document that are overwritten responsive to the hashes for chunks of an incoming document having a same identifier as a document stored in a database not matching the hashes for chunks of the document stored in the database. For another example, the metric collector 128 records a number of times that an incoming folder, file, or document has a hash that does not match a stored folder, file, or document having a same identifier.

The metric visualizer 130 is a component that transforms metrics that are recorded by the metric collecter 128 into a human-readable format. In example embodiments, the metrics are arranged in a data table, graph, chart, plot, or the like. In some embodiments, the metric visualizer 130 includes a graphing engine that generates visualization of the recorded metrics and/or an indication system for identifying an outlier or a metrics that exceeds a threshold. In an embodiment, the metric visualizer presents the visualized metrics in an interactive dashboard accessible to a user via a computing device.

The interface 135 facilitates interaction with the data management engine 110. For example, the interface 135 facilitates communicating with external computing devices and/or with input/output operations. The interface 135 refers to hardware and/or software configured to facilitate communication between a user device and a system. In FIG. 1, an interface 135 is used to facilitate communication between the data management engine 110 and other components of the system and/or external components (e.g., one or more user computing devices, client computing devices, and/or administrative computing devices). Such an interface 135 renders user interface elements and receives input via user interface elements.

Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, forms, etc. In various embodiments, different components of such an interface are specified in different languages. The behavior of user interface elements is specified in a dynamic programming language such as JavaScript. The content of user interface elements is specified in a markup language, such as hypertext markup language (“HTML”) or extensible markup language (“XML”) User Interface Language (“XUL”). The layout of user interface elements is specified in a style sheet language such as Cascading Style Sheets (“CSS”). Alternatively, interfaces may be specified in one or more other languages, such as Java, C, or C++.

In various embodiments, one or more data sources 140 include one or more data artifacts 142 that are arranged according to a data structure 144. For example, a data source 140 stores a data artifact that includes multiple data folders. In some cases, a data folder stores data that is related to a particular service. Some data folders include multiple files. Some files include multiple documents. Some documents include multiple document chunks. Some document chunks are text chunks, whereas other document chunks are image chunks that contain images. Some document chunks include content that is a modality other than text or image. For example, a document chunk includes audio, video, and/or other data.

In another embodiment, a data structure 144 comprises a pointer system. For data that is stored using a pointer system, records or data objects are referenced using pointers instead of duplicating the data. This improves efficiency by reducing redundancy and storage costs while ensuring consistency across datasets. Pointer systems are suitable for databases, file systems, and memory management to enable fast lookups and updates. Different data structures are hierarchical, such a tree, or non-hierarchical, such as a linked list or graph.

As illustrated in FIG. 1, the data repository 150 includes hash table data 152, artifact data 154, metric data 156, image embedding data 162, document chunk metrics 164, and semantic processing data 166. In this context, the hash table data 152 includes hashes and identifiers for stored and/or incoming data artifacts, folders, files, documents, or document chunks. The artifact data 154 includes the contents of data artifacts, including chunks of documents contained in a data hierarchy of the artifacts. For example, artifact data 154 includes new folders, files, documents and/or chunks that are ingested and stored in the data repository. Artifact data 154 also includes changed folders, files, documents and/or chunks that have a matching identifier to previously stored data and which overwrite previously stored data. The metric data includes metrics such as the number of folders changed, the number of files changed, the number of documents changed, the number of document chunks changed, the density of changes within a document chunk, the frequency of such changes, an amount of time to ingest a data artifact, and/or the like. The semantic processing data 158 includes data that is generated by semantically processing document chunks. For example, when an incoming document chunk that is being ingested has a hash value that does not match the hash value for a document chunk having a same identifier, the incoming document chunk is processed to extract a topic or keyword, or to define a tone, sentiment, or other attribute of the document chunk. The extracted topic or keyword, or other attribute of the incoming document chunk are stored as semantic processing data 158.

In embodiments, a data repository 150 stores data for the data management system 100 Generally, the data repository 150 stores data used and/or generated by the data management engine 110, such as data related to hash tables and collected metrics. In embodiments, ingested data is also stored in the data repository 150. In embodiments, the ingested data is stored in a data storage location managed by a distributed search engine such as an OpenSearch. The data repository 150 optionally stores data loaded from other sources. In some embodiments, data is separately stored by type of the data or organized by a type of the data in the data repository 150 and/or one or more other data storage devices.

For example, the data management engine 110 is configured for ingesting, managing, storing and/or monitoring data that is indexed by a distributed search engine 160 such as an OpenSearch. The data is stored in a data storage managed by the distributed search engine 160 responsive to an instruction from the data management engine 110.

In an embodiment, the data management system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (“NAT”), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Example Operations for Data Management Using Cascading Hash and/or Image Embedding

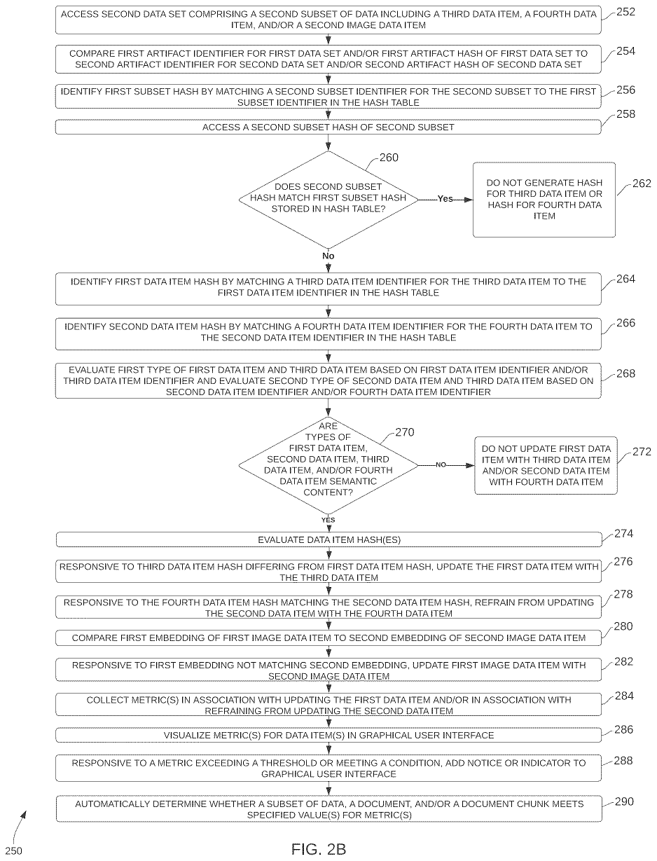

FIG. 2A illustrates example operations 200 for data management using cascading hash and/or image embedding. For example, operations 200 are performable by the data management engine 110 and/or components of the data management system 100 of FIG. 1.

In FIG. 2, the data management engine accesses a first data set comprising a first subset of data including a first data item, a second data item, and/or a first image data item (Operation 202). In general, a data set can include data having a hierarchy or parent/child relationship between data layers. For example, a data artifact includes folders. Folders include files. Files include documents, and so forth. In embodiments, a data layer includes any number of sublayers, sub-sublayers, and so forth.

The data management engine accesses a first subset hash for the first subset of data (Operation 204). For example, the engine generates a hash for a folder, file, or other data subset, of the data set using a hash algorithm or receives a hash value for the folder, file, or other data subset from another source.

The data management engine accesses a first data item hash for the first data item (Operation 206). For example, the engine generates a hash for a first document chunk of the data set using a hash algorithm or receives a hash value for the data item from another source.

The data management engine accesses a second data item hash for the second data item (Operation 208). In this operation, the engine generates a hash for a second document chunk of the data set using a hash algorithm or receives a hash value for the data item from another source.

The data management engine stores a first subset identifier in association with the first subset hash in the hash table (Operation 210). In embodiments, the data management engine stores identifiers for an artifact, folder, subfolder, file, subfile, document, directory location, and/or other data subset in different hash tables, or in a unified hash table.

The data management engine stores a first data item identifier in association with the first data item hash in a hash table (Operation 212). In embodiments, the data management engine generates a hash table and stores the first data item identifier and the first data item hash in mutual association in the hash table. In the example, the hash table includes hashes for the data items. In various embodiments the engine generates one or more hash tables including: an artifact hash stored in association with an artifact identifier; a folder hash stored in association with a folder identifier; a file hash stored in association with a file identifier; a document hash stored in association with a document identifier; a document chunk hash stored in association with a document chunk. In various embodiments, the engine generates a separate hash table for data layers and/or generates a unified hash table including different data layers.

The data management engine stores a second data item identifier in association with the second data item hash in the hash table (Operation 214). In general, the engine stores a plurality of unique identifiers for a plurality of data items in a data layer in the hash table. In various embodiments, the unique identifiers include tags, labels, or the like, indicating a type of the data item. For example, a first folder of a data artifact is related to one service type, and a second folder of a data artifact is related to a second service type, which may be different. As another example, a document chunk is related to the meaning, content, or body of a document, and a second document chunk is related to formatting for and/or metadata (e.g., timestamp, location, authorship, etc.) about the document.

The engine chunks a document by header, subheader, topic, metadata flags, and/or other delineations. In this way, document chunks containing semantic content such as body text are separated from non-semantic contents, such as formatting or script. In the example, the identifier for a document chunk includes an indication of the type of the document chunk. In different examples, the engine performs different actions on data items in a data layer based on the types of the data items. For example, a non-semantic data chunk is not semantically processed for key-word extraction or summarization.

The data management engine stores a first embedding of the first image data item in the hash table (Operation 216). For example, the system chunks a document into a document chunk that has an image as the contents of the document chunk. The engine generates an encoding or embedding of the image data item. In an implementation, the engine generates a Base64 encoding of the image and stores the encoding in an image hash table, in a document chunk hash table, and/or in a unified hash table.

FIG. 2B illustrates example operations 250 for data management using cascading hash and/or image embedding. For example, operations 200 are performable by the data management engine 110 and/or components of the data management system 100 of FIG. 1.

In FIG. 2B, the data management engine accesses a second data set comprising a second subset of data including a third data item, a fourth data item, and/or a second image data item (Operation 252). In various embodiments, the second data set is a new or incoming data set. For example, the system periodically generates or receives snapshots of distributed search engine data, and the second data item is a data artifact that is a new or incoming snapshot of the distributed search engine data.

The engine compares an identifier of the second data set to an artifact identifier stored in a hash table. The engine compares one or more data layer identifiers of the second data set to corresponding identifiers for the data layers of already ingested data in the hash table. For example, the engine compares hashes of data layers from a top layer to a bottom layer in a cascading fashion to correlate corresponding incoming data items and data layers to the data that is previously stored in data storage. The data storage is accessible by a distributed search engine for a system stores snapshot data of the system.

The data management engine compares a first artifact identifier for the first data set and/or a first artifact hash of the first data set to a second artifact identifier for the second data set and/or a second artifact hash of the second data set (Operation 254). In various embodiments, the engine determines that the second data set corresponds to the first data set by determining whether an artifact identifier for the first data set matches or corresponds to an artifact identifier for the second data set. In embodiments, the engine compares a hash for the second data set to an artifact hash stored in a hash table. If the hashes match, this indicates that no changes have occurred to the data and the engine does not check identifiers or hashes for other data layers that are lower in the data hierarchy.

The data management engine identifies the first subset hash by matching a second subset identifier to the first subset identifier in the hash table (Operation 256). In this operation, the engine accesses a second subset identifier for the second subset and compares this identifier to values in a hash table containing subset identifiers for subsets of data at a same data layer. For example, the second subset identifier identifies a folder or file. The second subset identifier matching a subset identifier in the hash table indicates that the folder or file of the second data artifact corresponds to a same folder or file of the first artifact. If the data management engine does not find a subset identifier in the hash table that matches the second subset identifier, this indicates that the folder or file is a new folder or new file. In this case, the engine generates a new subset hash for the new folder or file and stores the new subset hash in association with the second subset identifier in the hash table.

The data management engine accesses a second subset hash of the second subset (Operation 258). For example, the data management engine generates a second subset hash of the second subset of data or receives the second subset hash from another source.

The data management engine determines whether the second subset hash matches the first subset hash stored in the hash table (Operation 260). In embodiments, responsive to the engine matching the second subset identifier to the first subset identifier in the hash table, the engine compares the subset hashes to determine if a change has been made to the subset of data. For example, a folder hash for the second data artifact is compared to a folder hash that is stored in the hash table to determine if the folder hash for the second data artifact matches the folder hash that is stored in the hash table for a same identifier. In various embodiments, subsets of data include artifacts, folders, files, directories, documents, collections, trees, linked lists, and/or other subsets of data. For pairs of subsets of data in a same data layer where the subset hashes differ, the engine proceeds by processing the next data layer of the subsets. For pairs of subsets of data in a same data layer for which the subset hashes are the same, the engine proceeds by processing the subset of data in the data layer.

If the second subset hash does match the first subset hash stored in the hash table, the data management engine does not generate a hash for the third data item or a hash for the fourth data item (Operation 262). In this operation, responsive to determining that the first subset hash and the second subset hash are the same, the engine proceeds to a next subset of the second data artifact. Since the first subset hash and the second subset hash match, this indicates that the data in the first subset of the first artifact is the same as the data in the subset of the second artifact having the matching identifier.

If the second subset hash does not match the first subset hash stored in the hash table, the data management engine identifies the first data item by matching a third data item identifier for the third data item to the first data item identifier in the hash table. (Operation 264). For example, a data item hash for a first document chunk is stored in the hash table. The engine identifies the data item hash for the first document chunk by matching the third data item identifier for the third data item to a document chunk identifier for the first document chunk that is stored in the hash table. In an example embodiment, the first data item identifier for the first document chunk includes a URL that identifies a location of the first document chunk. The first data item identifier includes one or more of a chunk number (indicating the relative position of the first document chunk in the document indicated by the URL), a chunk type (indicating whether the first document chunk contains semantic content, formatting information, JavaScript, or CSS, etc.), and/or a chunk topic (indicating a topic, keyword, or the like, for the first document chunk).

The data management engine identifies the second data item by matching a fourth data item identifier for the fourth data item to the second data item identifier in the hash table (Operation 266). In an example, the third data item and the fourth data item are document chunks of an HTML document whose location is indicated by a URL. The third data item identifier includes the URL, a first chunk number, and a first chunk type, and the fourth data item identifier includes the URL, a second chunk number, and a second chunk type.

The data management engine evaluates a first type of the first data item and the third data item based on the first data item identifier and/or the third data item identifier and evaluates a second type of the second data item and the fourth data item based on the second data item identifier and/or the fourth data item identifier (Operation 268). For example, the engine determines whether the first data item and the third data item include semantic content or formatting data based on the data item identifier for the first data item and/or the third data item including a tag that indicates whether the identifier corresponds to a semantic content chunk or a non-semantic content chunk. Likewise, the engine determines whether the second data item and the fourth data item include semantic content or formatting data based on the data item identifier for the second data item and/or the fourth data item including a tag that indicates whether the identifier corresponds to a semantic content chunk or a non-semantic content chunk.

In various embodiments, the engine evaluates an identifier to determine a topic, key-word, or other attribute of a data item. The engine evaluates the identifier algorithmically, using natural language processing, image processing module 120 includes various functions, algorithms, and/or models that generate encodings from images and/or that that analyze images to detect objects in, enhance, or compress the images. In embodiments, the image processing module 120 includes an image formatting model that normalizes, resizes, or converts an image to a standard format.

The data management engine determines whether the types of the first data item, second data item, third data item and/or fourth data item are semantic content (Operation 270). For example, the engine determines that a data item that is a document chunk containing CSS, JavaScript, or other scripting components is not a semantic content type document chunk. The engine determines that a data item that is a document chunk containing body text of a document is a semantic content type document chunk. In embodiments, the respective data item identifiers indicate the modalities of the data items.

Responsive to the types of the first data item, the second data item, the third data item, and/or the fourth data item not being semantic content, the data management engine does not update the first data item with the third data item and/or does not update the second data item with the fourth data item (Operation 272). In embodiments, based on the first data item and the third data item not being semantic content, the first data item is not updated with the third data item. In embodiments, based on the first data item and the third data item not being semantic content, the third data item is not semantically processed for summarization and/or key-word extraction. Likewise, in embodiments, based on the second data item and the fourth data item not being semantic content, the second data item is not updated with the fourth data item. In embodiments, based on the second data item and the fourth data item not being semantic content, the fourth data item is not semantically processed for summarization and/or key-word extraction.

If the types of the first data item, the second data item, the third data item, and/or the fourth data item are semantic content, the engine evaluates one or more data item hashes (Operation 274). In various embodiments, an artifact, folder, file, or document includes a plurality of data items. The engine compares one or more pairs of hashes for corresponding pairs of data items that have matching identifiers to determine whether the incoming data item has changes relative to or is the same as the corresponding stored data item.

Responsive to the third hash differing from the first hash, the data management engine updates the first data item with the second data item (Operation 276). In an example embodiment, a document is stored in a data snapshot artifact at a location described by a URL. A chunk of the document is hashed to generate the second data item hash. The snapshot is ingested such that an identifier for the chunk and the second data item hash are recorded in a hash table during ingestion. When the engine processes a subsequent snapshot, the engine hashes the corresponding chunk of the document located at the corresponding URL for in the subsequent snapshot matching the URL of the stored document. Responsive to the hashes differing, the engine overwrites the stored chunk of the document with the corresponding chunk of the document in the subsequent snapshot. In some embodiments, updating the first data item with the second data item comprises interfacing with a distributed search engine to cause the engine to update pointers or data associated with the first data item. For example, the system transmits an API command to copy data between indices in OpenSearch using an API command (e.g., an index or reindex command) suitable for transferring documents from a source index to a destination index. Some such operations read documents from a source snapshot and index them into a target storage location. For example, the system writes or overwrites data associated with the first data item, at location associated with an OpenSearch index, with the second data item. In another example, the system changes a pointer associated with the OpenSearch index so that the pointer refers to the second data item instead of the first data item.

Responsive to the fourth hash matching the second hash, the data management engine refrains from updating the second data item with the fourth data item (Operation 278). For example, a document is stored at a location described by a URL. A second chunk of the document is hashed to generate the second data item hash. A snapshot of the data storage is ingested such that an identifier for the second chunk and the second data item hash are stored in the hash table. When the engine processes a subsequent snapshot, the engine hashes the second chunk of the document located at the corresponding URL for the subsequent snapshot that matches the URL of the stored document. Responsive to the hashes matching, the engine does not overwrite the stored second chunk of the document with the corresponding second chunk of the document in the subsequent snapshot.

The data management engine compares a first embedding of the first image data item to a second embedding of the second image data item (Operation 280). In the example, the engine chunks documents into semantic chunks, non-semantic chunks, and image chunks. An image of an image chunk of a document is represented by an encoding or embedding that is stored in the hash table in association with an identifier for the image. Identifiers for images include a URL of the document containing the image, a tag indicating that the chunk is an image chunk, and/or a chunk number of the chunk. The engine identifies the first embedding in the hash table based on matching the identifier for the second image data item to the identifier for the first image data item stored in the hash table. The identifier indicates a modality of the image data item, such as a type of encoding.

Responsive to the first embedding not matching the second embedding, the data management engine updates the first image data item with the second image data item (Operation 282). For example, the engine determines that the embedding for an incoming image of an HTML document does not match the embedding that is stored in the hash table in association with an identifier that matches the URL and/or chunk number of the incoming image of the HTML document. Responsive to this determination, the engine overwrites the image at the storage location described by the URL with the second image data item and replaces the embedding in the hash table that matches the URL and/or chunk number with the embedding of the second image data item.

The data management engine collects one or more metrics in association with updating the first data item and/or in association with refraining from updating the second data item (Operation 284). In this operation, the data management engine collects metrics recording the frequency of changes, volume of changes, and/or ingestion time, etc. for one or more data layers or data items (e.g., an artifact, folder, file, document, document chunk, etc.) In various embodiments, the metrics are aggregated and/or grouped by service type (e.g., by a file or folder or collection of files or folders), topic, key-word, or other attribute. For example, the engine records a frequency of changes (and/or other metric) to one or more document chunks in a folder as well as the frequency of changes (and/or other metric) to one or more document chunks associated with a topic or keyword.

The data management engine, visualizes one or more metrics for one or more data items in a graphical user interface (Operation 286). In various embodiments, the engine represents the one or more metrics graphically in a graphical user interface element such as a chart, graph, or plot. The system uses the metrics to identify artifacts, folders, files, documents, topics, services, or the like, of data snapshots, which have certain attributes definable by the metrics.

Responsive to a metric exceeding a threshold or meeting a condition, engine adds a notice or indicator to the graphical user interface (Operation 288). For example, a document that includes chunks that are frequently overwritten during subsequent snapshot ingestions is flagged in a graphical user interface. In another example, a plurality of document chunks are semantically processed to determine that the plurality of documents are associated with a particular topic or key-word. Topics or keywords for which document chunks associated with the topic or key-word are frequently overwritten during subsequent snapshot ingestions are optionally flagged or otherwise indicated in the graphical user interface.

The engine automatically determines whether a subset of data, a document, and/or a document chunk meets a specified value or specified values for one or more metrics (Operation 290). Responsive to the engine determining that a data set, subset, or data item meets the specified value(s), that set, subset, or item is automatically deployed to a cloud storage. For example, a cloud deployment of a customer service system includes a plurality of documents providing customer service information. Responsive to a metric meeting a condition for a document, the document is saved in a knowledge base for the customer service system. Continuing the example, responsive to the frequency of changes to a document being above a threshold, the document is removed from and/or not deployed to the cloud storage for the customer service system.

### 4. Example Data Management Techniques Using Cascading Hash and/or Image Embedding Table(s)

### 4.1Example Data Ingestion and Hash Table Construction

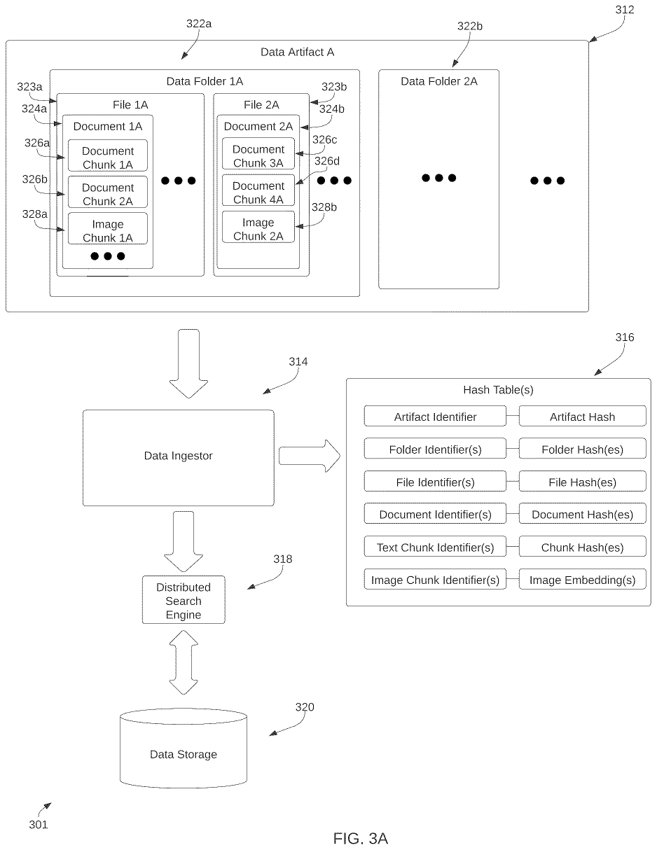

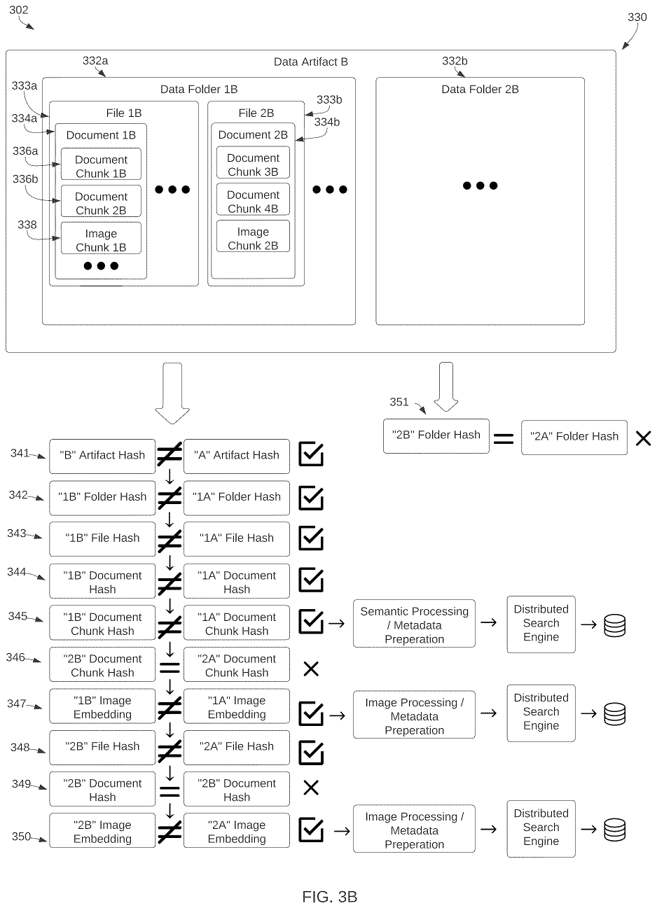

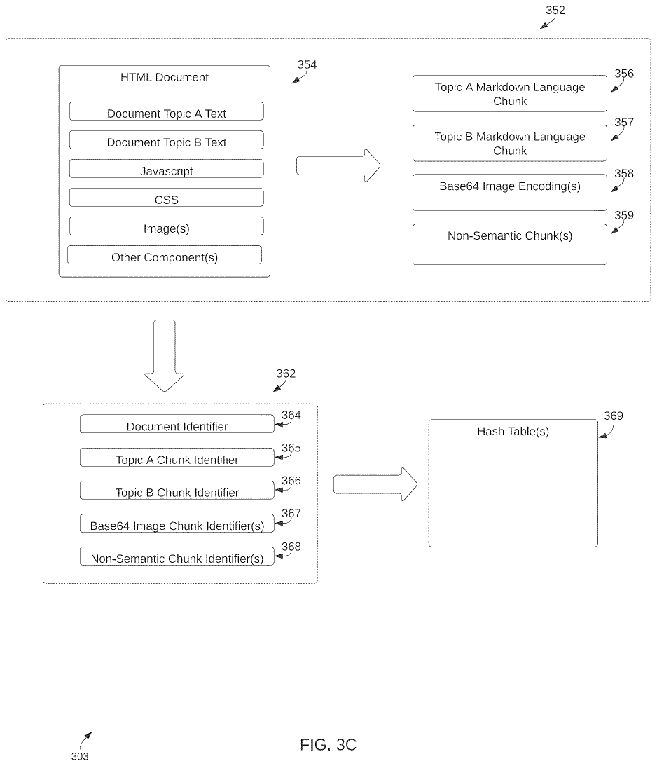

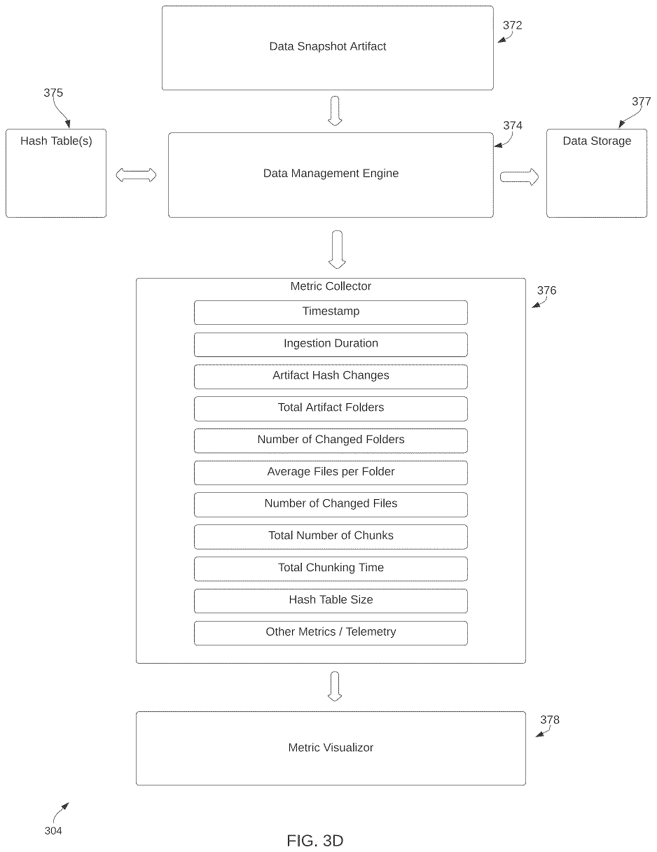

FIG. 3A illustrates an example 301 of data ingestion and hash table construction techniques. In FIG. 3A, a data artifact 312 is ingested by a data ingestor 314. Once ingested, the ingested data is indexed and/or managed by a distributed search engine 318. The ingested data is stored at a data storage 320 that is managed by the distributed search engine 318. One example of a suitable distributed search engine is OpenSearch.

The data ingestor 314 generates one or more hash tables 316 for the ingested data. The hash table(s) store hashes for various data items and data layers of the data artifact 312. In various embodiments, the hash table(s) include one or more tables that store an artifact level-hash, one or more folder-level hashes, one or more file-level hashes, one or more document-level hashes, one or more document chunk-level hashes, and/or one or more hashes for another data layer or data directory. In different embodiments, the hashes are stored in one hash table, or in separate hash tables for the data layer levels.

When a subsequent incoming data set is being ingested, the engine compares identifiers for the incoming data to determine hash values that are stored in association with the identifiers. The engine generates a hash for the top-most data layer of the incoming data set (in the example, the artifact layer of a snapshot). Responsive to the generated hash for the new data set matches the hash for the identified hash of the stored hash table, the engine refrains from generating hashes for subsets of the data set and data items. This is because the hashes matching indicates that the incoming data set in the same as the data set that is in storage which corresponds to the identified hash.

In the example, the data artifact 312 (Data Artifact A) includes a plurality of data folders including a first data folder 322a (Data Folder 1A), a second data folder 322b (Data Folder 2A), and optionally one or more additional folders. The first data folder 322a includes any number of subfolders or sub-subfolders. The first data folder 322a include a first data file 323a (File 1A), a second data file 323b (File 2A), and optionally one or more additional files. A file of the first data file 323a includes a first document 324a, a second document 324b, and optionally one or more additional documents. The first document includes a first document chunk 326a (Document Chunk 1A), a second document chunk 326b (Document Chunk 2A), an image chunk 328 (Image Chunk 1A), and optionally one or more additional chunks. The second document 324b includes a first document chunk 326c (Document Chunk 3A), a second document chunk 326d (Document Chunk 4A), an image chunk 328b (Image Chunk 2A), and optionally one or more additional chunks. Various data artifacts have any number of folders, files, documents, etc.

### 4.2 Example Data Ingestion and Hash Table Comparison

FIG. 3B illustrates and example 302 data ingestion and hash table comparison. In the example 302, a data artifact 332 is ingested by a data management system. The data artifact 332 includes one or more folders, files, documents, and chunks in a hierarchical data structure.

In FIG. 3B, the data artifact 330 (Data Artifact B) includes a plurality of data folders including a first data folder 332a (Data Folder 1B), a second data folder 332b (Data Folder 2B), and optionally one or more additional folders. The first data folder 332a (Data Folder 1B) includes any number of subfolders or sub-subfolders. The first data folder 332a (Data Folder 1B) include a first data file 333a (File 1B), a second data file 333b (File 2B), and optionally one or more additional files. A file of the first data file 333a includes a first document 334a, a second document 334b, and optionally one or more additional documents. The first document includes a first document chunk 336a (Document Chunk 1B), a second document chunk 336b (Document Chunk 2B), an image chunk 338 (Image Chunk 1B), and optionally one or more additional chunks.

In the example 302 of FIG. 3B, data management engine ingests a subsequent data artifact 330 (Data Artifact B). As shown in FIG. 3B, the engine compares an artifact hash 341 for the subsequent data artifact 330 to a corresponding artifact hash identified from a hash table. In the example, the compared artifact hashes differ. Responsive to the artifact hashes differing, the engine proceeds to compare hashes for folders of the data artifact 330 to hashes for corresponding folders in the hash table.

As illustrated in FIG. 3B, the engine compares an folder hash 342 for the subsequent data artifact 330 to a corresponding folder hash identified from the hash table. In the example, the compared folder hashes differ. Responsive to the folder hashes being different, the engine proceeds to compare hashes for files of the folder to hashes for corresponding files in the hash table.

In FIG. 3B, the engine compares a file hash 343 for the subsequent data artifact 330 to a corresponding file hash identified from the hash table. In the example, the compared file hashes differ. Responsive to the file hashes being different, the engine proceeds to compare hashes for documents of the files to hashes for corresponding documents in the hash table.

As shown in FIG. 3B, the engine compares a document hash 344 for the subsequent data artifact 330 to a corresponding document hash identified from the hash table. In the example, the compared document hashes differ. Responsive to the document hashes being different, the engine proceeds to compare hashes for document chunks of the document to hashes for corresponding document chunks in the hash table.

In FIG. 3B, the engine compares a document chunk hash 345 for the subsequent data artifact 330 to a corresponding document chunk hash identified from the hash table. In the example, the compared document chunk hashes differ. Responsive to the document hashes being different, the engine semantically processes the document chunk using a language model. For example, the engine generates a summary, extracts a key-word, and/or identifies a topic, theme, intent, or other attribute of the document chunk. The result of the semantic processing and the document chunk are stored and/or provided to a distributed search engine service. The document chunk and the result of the semantic processing are used to overwrite the stored document chunk and/or a previous result of semantic processing.

In another example, an image processing module executes functions, algorithms, and/or models that generate encodings from an image or an image chunk of a document. The system analyzes an image to name an object, generate a summary, extract a key-word, and/or identify a topic, theme, intent, or other attribute of an image. The system generates an encoding as a representation of the image data and/or the object name, summary, key-word, topic, theme, and/or the like. The result of the encoding and the image chunk are stored and/or provided to the distributed search engine service. The image chunk and the result of the encoding are used to overwrite the stored image chunk and/or a previous result of encoding the image chunk.

In some embodiments, the engine evaluates an identifier for a document chunk to determine if the document chunk is an image chunk, a semantic text chunk, or a non-semantic text chunk. In some cases, the engine does not overwrite a non-semantic text chunk responsive to evaluating the identifier to determine that the chunk is non-semantic. For example, a chunk is determined to be non-semantic according to a tag or other indicator in a document indicating that the chunk includes formatting, script, or another non-semantic element.

As shown in FIG. 3B, the engine compares a second document chunk hash 346 for the subsequent data artifact 330 to a corresponding second document chunk hash identified from the hash table. In this example, the compared second document chunk hashes are the same. Responsive to the second document chunk hashes being the same, the second document chunk is not semantically processed or used to overwrite a stored document chunk.

As illustrated in FIG. 3B, the engine compares an image embedding 347 for the subsequent data artifact 330 to a corresponding image embedding from the hash table. In this example, the compared image embeddings differ. Responsive to the image embeddings being different, the corresponding image of the subsequent data artifact 330 is processed by an image processing model to generate a summary, extract a key-word, and/or identify a topic, theme, intent, or other attribute of the image. In this example, the image and the result of the image processing are stored and/or provided to the distributed search engine service.

In FIG. 3B, the engine compares a second file hash 348 for the subsequent data artifact 330 to a corresponding second file hash identified from the hash table. In the example, the compared file hashes differ. Responsive to the file hashes being different, the engine proceeds to compare hashes for documents of the second file to hashes for corresponding documents in the hash table.

The engine compares a second document hash 349 for the subsequent data artifact 330 to a corresponding second document hash identified from the hash table. In the example, the compared document hashes are the same. Responsive to the document hashes being the same, the engine does not compare hashes for document chunks of the document and/or does perform semantic processing on the document.

As illustrated in FIG. 3B, the engine compares a second image embedding 348, in the second file, for the subsequent data artifact 330, to a corresponding image embedding for the second image from the hash table. In this example, the compared image embeddings differ. Responsive to the image embeddings being different, the corresponding second image of the subsequent data artifact 330 is processed by the image processing model to generate a summary, extract a key-word, and/or identifies a topic, theme, intent, or other attribute of the second image. In this example, the second image and the result of the second image processing are stored and/or provided to the distributed search engine service.

In FIG. 3B, the engine compares a second folder hash 351 for the subsequent data artifact 330 to a corresponding second folder hash identified from the hash table. In the example, the compared folder hashes are the same. Responsive to the compared folder hashes being the same, the engine refrains from comparing identifiers and/or hashes for files of the second folder to corresponding second folder identifiers and/or hashes in the hash table.

### 4.3 Example HTML Document Chunking and Chunk Identifier Generation

FIG. 3C illustrates the operation of chunking module 352 on an HTML document 354. In the example, the HTML document includes headers and/or body text related to a first topic, headers and/or body text related to a second topic, JavaScript, CSS, one or more images, and/or other components. The system chunks the document into a first markdown language chunk 356 for the text related to the first topic, a second markdown language chunk 357 for the text related to the second topic, one or more Base64 image encoding chunks 358 of an image of the HTML document, and one or more non-semantic content related chunks 359 of the HTML document. In the example, the one or more non-semantic content related chunks 359 of the HTML document include JavaScript, CSS, or other components of the HTML document.

In FIG. 3C, an identifier generator 362 generates identifiers for the HTML document and the chunks of the HTML document. In the example, the identifier generator generates a document identifier 364, a first chunk identifier 365 for the first markdown language chunk of the HTML document, a second chunk identifier 366 for the second markdown language chunk of the HTML document, a third chunk identifier 367 for a Base64 image encoding chunk of the HTML document, and a fourth chunk identifier 368 for a non-semantic chunk of the HTML document.

In the example of FIG. 3C, the document identifier 364, the first chunk identifier 365, the second chunk identifier 366, the third chunk identifier 367 and the fourth chunk identifier 368 are stored in a hash table in association with respective hashes for the identified document or chunks.

### 4.4 Example Document Monitoring and Metric Visualization

FIG. 3D illustrates document monitoring and metric visualization for a data management system. In the example, a data snapshot artifact 372 is received by a data management engine 374. The data management engine 374 compares identifiers and hashes for the data snapshot artifact 372 to identifiers and hashes stored in one or more hash tables, such as hash table(s) 375.

In FIG. 3D, responsive to a hash for a data item of the data snapshot artifact 372 not matching a corresponding hash having a matching identifier that is stored in hash table 375, the data item loaded into data storage 377 at a data storage location that is determined by the matching identifier.

In the example of FIG. 3D, The data management engine 374 provides metrics to the metric collector 376. In the example, the metric collector 376 collects metrics such as, but not limited to, a start time of ingestion of a document chunk, a completion time of ingestion of a document chunk, a start time or completion time of a data layer or directory, a total duration of ingestion for a data artifact, a number of total folders, a number of changed folders, a number of average files per folder, a number of changed files, number of chunks, a chunking time for the data snapshot artifact 372, a size of the hash table 375, and/or other metrics or telemetry.

As illustrated in FIG. 3D, a metric visualizer 378 generates visualizations of one or more metrics. The visualizations include graphs, chart, plots, tables, and/or the like. The visualization are generated by topic, by service, by folder, by document, or based on other parameters. In some embodiments, the system flags one or more folders, files, services, documents, and/or document chunks responsive to a condition that is based on a value for a metric. For example, a document that is changed frequently (e.g., a document that is changed more than 15% of snapshot ingestions, or more or less frequently), or which has a high volume of changes (e.g. a document for which more than 50% of the document chunks were changed, or a higher or lower volume of changes) is flagged in a visualization of the collected metrics. As another example, a document chunk is flagged based on the frequency of change or the volume of words of the chunk that are changed. In another example, a file is flagged based on the frequency or volume of changes to documents in the file. In yet another example, a folder or service is flagged based on the frequency or volume of changes to files in the folder or associated with the service. These data layers and/or other data layers are flagged responsive to these or other metrics exceeding a threshold value in various embodiments.

### 5. Machine Learning Architecture

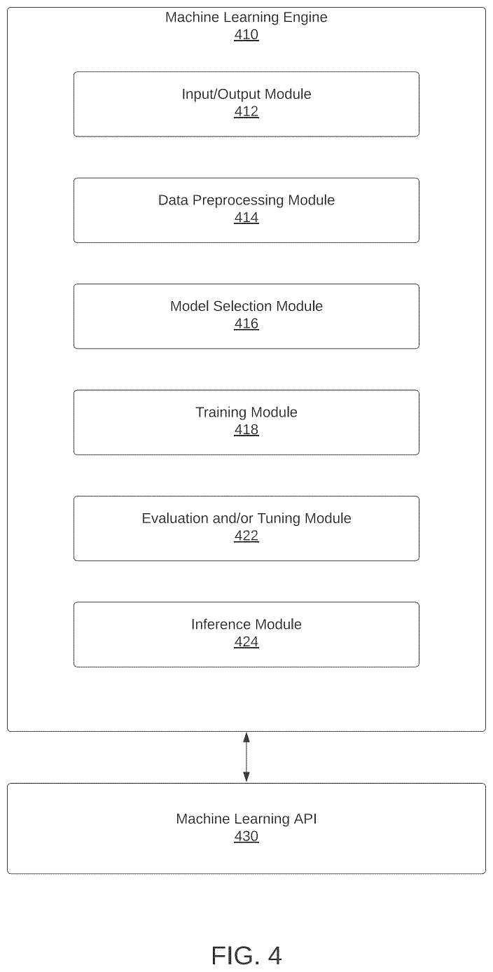

FIG. 4 illustrates a machine learning engine 410 in accordance with one or more embodiments. As illustrated in FIG. 4, machine learning engine 410 includes input/output module 412, data preprocessing module 414, model selection module 416, training module 418, evaluation and tuning module 422, and inference module 424.

In accordance with an embodiment, input/output module 412 serves as the primary interface for data entering and exiting the system, managing the flow and integrity of data. This module may accommodate a wide range of data sources and formats to facilitate integration and communication within the machine learning architecture.

In an embodiment, an input handler within input/output module 412 includes a data ingestion framework capable of interfacing with various data sources, such as databases, Application Programming Interfaces (API)s, file systems, and real-time data streams. This framework is equipped with functionalities to handle different data formats (e.g., CSV, JSON, XML) and efficiently manage large volumes of data. It includes mechanisms for batch and real-time data processing that enable the input/output module 412 to be versatile in different operational contexts whether processing historical datasets or streaming data.

In accordance with an embodiment, input/output module 412 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 412 includes an output framework designed to handle the distribution and exportation of outputs, predictions, or insights. Using the output framework, input/output module 412 formats these outputs into user-friendly and accessible formats, such as reports, visualizations, or data files compatible with other systems. Input/output module 412 also ensures secure and efficient transmission of these outputs to end-users or other systems in an embodiment and may employ encryption and secure data transfer protocols to maintain data confidentiality.

In accordance with an embodiment, data preprocessing module 414 transforms data into a format suitable for use by other modules in machine learning engine 410. For example, data preprocessing module 414 may transform raw data into a normalized or standardized format suitable for training ML models and for processing new data inputs for inference. In an embodiment, data preprocessing module 414 acts as a bridge between the raw data sources and the analytical capabilities of machine learning engine 410.

In an embodiment, data preprocessing module 414 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods, like imputation or removal of incomplete records, depending on the nature and volume of the missing data. Data preprocessing module 414 may be configured to handle anomalies in different ways depending on context. Data preprocessing module 414 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 414 includes a feature encoding framework that ensures categorical variables are transformed into a format that can be easily interpreted by machine learning algorithms. Techniques, such as one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 414 processes new data for inference, data preprocessing module 414 replicates the same preprocessing steps to ensure consistency with the training data format. This helps to avoid discrepancies between the training data format and the inference data format, thereby reducing the likelihood of inaccurate or invalid model predictions.

In an embodiment, model selection module 416 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 416 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 416 utilizes techniques from the field of Automated Machine Learning (AutoML). AutoML systems automate the process of model selection by rapidly prototyping and evaluating multiple models. They use various techniques, like Bayesian optimization, genetic algorithms, or reinforcement learning, to explore the model space efficiently. Model selection module 416 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. Mean squared error measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 416 also considers computational efficiency and resource constraints. This is meant to help ensure the selected model is both accurate and practical in terms of computational and time requirements. In an embodiment, certain features of model selection module 416 are configurable such as a configured bias toward (or against) computational efficiency.

In accordance with an embodiment, training module 418 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 418 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 418 manages overfitting, where a model learns the training data too well, including its noise and outliers, at the expense of its ability to generalize to new data. Techniques, such as regularization, dropout (in neural networks), and early stopping, are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 418 includes logic to handle different types of data and learning tasks. For instance, it includes different training routines for supervised learning (where the training data comes with labels) and unsupervised learning (without labeled data). In the case of deep learning models, training module 418 also manages the complexities of training neural networks that include initializing network weights, choosing activation functions, and setting up neural network layers.

In an embodiment, evaluation and/or tuning module 422 incorporates dynamic feedback mechanisms and facilitates continuous model evolution to help ensure the system's relevance and accuracy as the data landscape changes. Evaluation and tuning module 422 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 422 performs continuous model tuning by using hyperparameter optimization. Evaluation and tuning module 422 performs an exploration of the hyperparameter space using algorithms, such as grid search, random search, or more sophisticated methods like Bayesian optimization. Evaluation and tuning module 422 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 422 integrates data feedback and updates the model. Evaluation and tuning module 422 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 422 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 422 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 424 transforms raw data into actionable, precise, and contextually relevant predictions. In addition to processing and applying a trained model to new data, inference module 424 may also include post-processing logic that refines the raw outputs of the model into meaningful insights.

In an embodiment, inference module 424 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 424 transforms the outputs of a trained model into definitive classifications. Inference module 424 employs the underlying model as a tool to generate probabilistic outputs for each potential class. It then engages in an interpretative process to convert these probabilities into concrete class labels.

In an embodiment, when inference module 424 receives the probabilistic outputs from the model, it analyzes these probabilities to determine how they are distributed across some or every potential class. If the highest probability is not significantly greater than the others, inference module 424 may determine that there is ambiguity or interpret this as a lack of confidence displayed by the model.

In an embodiment, inference module 424 uses thresholding techniques for applications where making a definitive decision based on the highest probability might not suffice due to the critical nature of the decision. In such cases, inference module 424 assesses if the highest probability surpasses a certain confidence threshold that is predetermined based on the specific requirements of the application. If the probabilities do not meet this threshold, inference module 424 may flag the result as uncertain or defer the decision to a human expert. Inference module 424 dynamically adjusts the decision thresholds based on the sensitivity and specificity requirements of the application, subject to calibration for balancing the trade-offs between false positives and false negatives.

In accordance with an embodiment, inference module 424 contextualizes the probability distribution against the backdrop of the specific application. This involves a comparative analysis, especially in instances where multiple classes have similar probability scores, to deduce the most plausible classification. In an embodiment, inference module 424 may incorporate additional decision-making rules or contextual information to guide this analysis, ensuring that the classification aligns with the practical and contextual nuances of the application.

In regression models, where the outputs are continuous values, inference module 424 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 424 incorporates domain-specific adjustments into its post-processing routine. This involves tailoring the model's output to align with specific industry knowledge or contextual information. For example, in financial forecasting, inference module 424 may adjust predictions based on current market trends, economic indicators, or recent significant events, ensuring that the outputs are both statistically accurate and practically relevant. In some cases this routine is fully automated without requiring manual intervention.

In an embodiment, inference module 424 includes logic to handle uncertainty and ambiguity in the model's predictions. In cases where inference module 424 outputs a measure of uncertainty, such as in Bayesian inference models, inference module 424 interprets these uncertainty measures by converting probabilistic distributions or confidence intervals into a format that can be easily understood and acted upon. This provides users with both a prediction and an insight into the confidence level of that prediction. In an embodiment, inference module 424 includes mechanisms for involving human oversight or integrating the instance into a feedback loop for subsequent analysis and model refinement.

In an embodiment, inference module 424 formats the final predictions for end-user consumption. Predictions are converted into visualizations, user-friendly reports, or interactive interfaces. In some systems, like recommendation engines, inference module 424 also integrates feedback mechanisms, where user responses to the predictions are used to continually refine and improve the model, creating a dynamic, self-improving system.

The Machine Learning API 430 is an interface that facilitates access to and interaction with the machine learning engine 410 by other modules and/or components of a system.

### 6. Machine Learning Operations

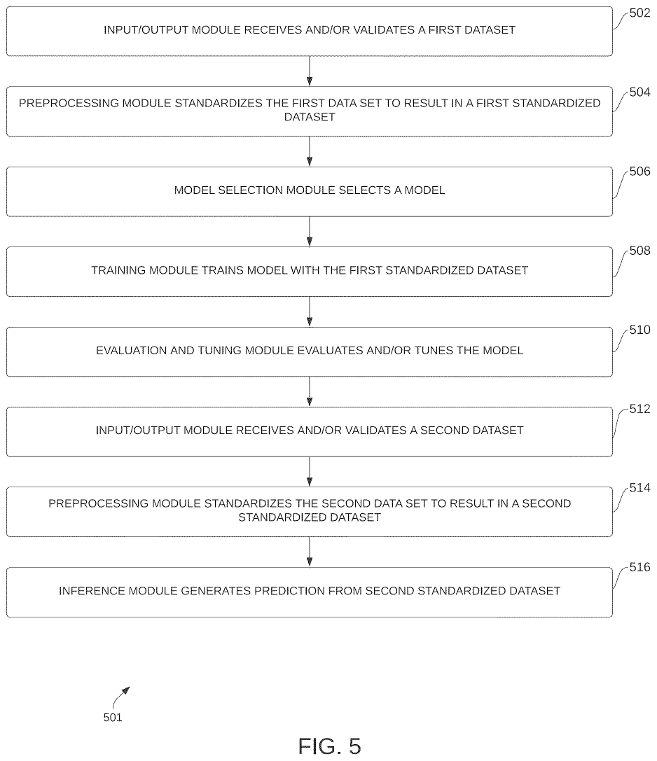

FIG. 5 illustrates a set of machine learning operations 500. In embodiments, one or more operations of the set of operations 500 is performed by a machine learning engine such as machine learning engine 410. In an embodiment, input/output module 412 receives a dataset intended for training (Operation 502). This data can originate from diverse sources, like databases or real-time data streams, and in varied formats, such as CSV, JSON, or XML. Input/output module 412 assesses and validates the data, ensuring its integrity by checking for consistency, data ranges, and types.

In an embodiment, training data is passed to data preprocessing module 414. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 414 is then fed into model selection module 416 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 418 trains the selected model with the prepared dataset (Operation 508). It implements learning algorithms to adjust the model's internal parameters, optimizing them to identify patterns and relationships in the training data. Training module 418 also addresses the challenge of overfitting by implementing techniques, like regularization and early stopping, ensuring the model's generalizability.

In an embodiment, evaluation and tuning module 422 evaluates the trained model's performance using the validation dataset (Operation 510). Evaluation and tuning module 422 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 412 receives a dataset intended for inference. Input/output module 412 assesses and validates the data (Operation 512).

In an embodiment, data preprocessing module 414 receives the validated dataset intended for inference (Operation 514). Data preprocessing module 414 ensures that the data format used in training is replicated for the new inference data, maintaining consistency and accuracy for the model's predictions.

In an embodiment, inference module 424 processes the new data set intended for inference, using the trained and tuned model (Operation 516). It applies the model to this data, generating raw probabilistic outputs for predictions. Inference module 424 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 430 allows for applications to leverage machine learning engine 410. In an embodiment, machine learning engine API 430 may be built on a RESTful architecture and offer stateless interactions over standard HTTP/HTTPS protocols. Machine learning engine API 430 may feature a variety of endpoints, each tailored to a specific function within machine learning engine 410. In an embodiment, endpoints such as “/submitData” facilitate the submission of new data for processing, while endpoints such as “/retrieveResults fetch the outcomes of data analysis or model predictions. Message level encryption (MLE) API also includes endpoints, such as “/updateModel” for model modifications and “/trainModel” to initiate training with new datasets.

In an embodiment, machine learning engine API 430 is equipped to support SOAP-based interactions. This extension involves defining a Web Services Description Language (WSDL) document that outlines the API's operations and the structure of request and response messages. In an embodiment, machine learning engine API 430 supports various data formats and communication styles. In an embodiment, machine learning engine API 430 endpoints may handle requests in JSON format or any other suitable format. For example, machine learning engine API 430 may process XML, and it may also be engineered to handle more compact and efficient data formats, such as Protocol Buffers or Avro, for use in bandwidth-limited scenarios.

In an embodiment, machine learning engine API 430 is designed to integrate WebSocket technology for applications necessitating real-time data processing and immediate feedback. This integration enables a continuous, bi-directional communication channel for a dynamic and interactive data exchange between the application and machine learning engine 410.

### 7. Generative Artificial Intelligence Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks, such as unsupervised learning, semi-supervised learning, and domain adaptation.

Large language models are designed to understand, generate, and interpret human language by processing extensive collections of data. The foundational architecture behind LLMs is the transformer network, a type of neural network that excels in handling sequential data such as text. Unlike certain architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers including a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to other elements is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 412, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 414 in the context of LLMs may include steps, such as normalization, where the text is converted to a uniform case and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 416, when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 418, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as GPUs (Graphics Processing Units) or TPUs (Tensor Processing Units), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 422 assesses the performance of LLMs using metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 424, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). An LMM is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for numerous applications, such as image captioning, text-to-image generation, image-to-text generation, visual question answering, and more, where understanding the relationship between different data types is crucial. By leveraging diverse datasets during training, LMMs learn to create coherent and contextually relevant outputs across various modalities, enhancing their utility in complex, real-world scenarios.

The architecture of LLMs combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of LMMs. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In LMMs, data preprocessing is a step that ensures the input data is in a suitable format for the model to process. This involves tasks, such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training LMMs involves optimizing their parameters through exposure to diverse datasets that include paired data from different modalities. This computationally intensive process often requires specialized hardware, like GPUs or TPUs, to manage the large volumes of data and the complexity of the model calculations. Techniques, such as dropout and layer normalization, are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of LMMs are conducted using various metrics tailored to the specific tasks they are designed to perform. For example, Bilingual Evaluation Understudy scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLMs and LMMs belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are designed for generating new data points by learning a distribution of some input data, by encoding inputs into a latent space, and/or by generating outputs by sampling from a latent space. An example VAE is therefore inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a taxonomic negative sampling-based machine learning system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment versions of a taxonomic negative sampling-based machine learning system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a taxonomic negative sampling-based machine learning system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied or outputs the name of the field or other context information for which the trigger condition was satisfied. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data that causes data to be moved into a data cloud.

In one or more embodiments, the exposed actions may receive, as input, a request to increase or decrease existing alert thresholds. The input might identify existing in-application alert thresholds and whether to increase, decrease, or delete the threshold. Additionally, or alternatively, the input might request the microservice application to create new in-application alert thresholds. The in-application alerts may trigger alerts to the user while logged into the application or may trigger alerts to the user using default or user-selected alert mechanisms available within the microservice application itself rather than through other applications plugged into the microservices manager.

In one or more embodiments, the microservice application may generate and provide an output based on input that identifies, locates, or provides historical data and defines the extent or scope of the requested output. The action, when triggered, causes the microservice application to provide, store, or display the output, for example, as a data model or as aggregate data that describes a data model.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

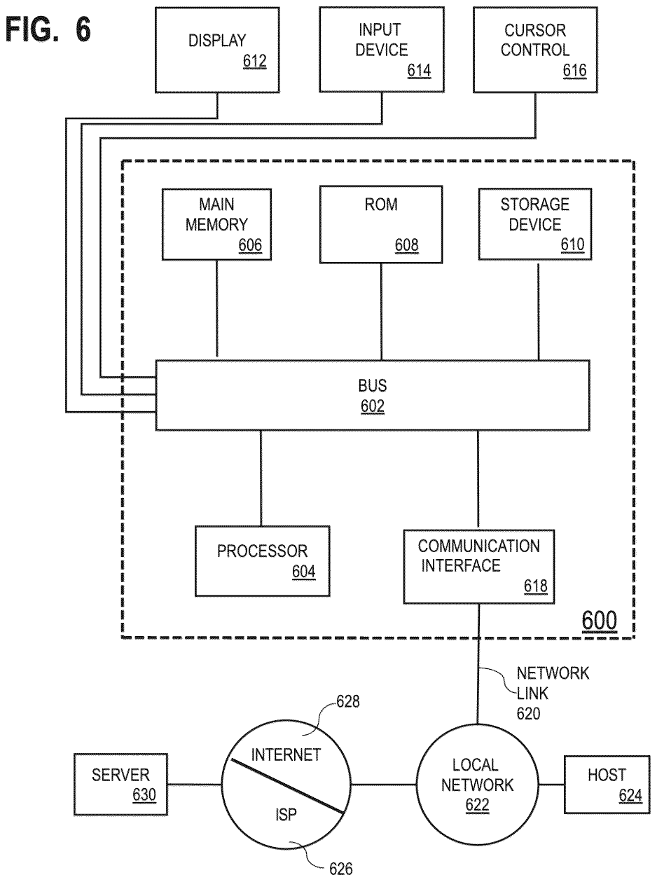

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602 Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
accessing a data set, the data set comprising a subset of data including a first data item and a second data item, the subset having a subset identifier, the first data item having a first identifier identifying (a) the data set, (b) the subset, and (c) the first data item, and the second data item having a second identifier identifying (a) the data set, (b) the subset, and the (c) second data item;
generating a first hash for the first data item;
generating a second hash for the second data item;
generating a first subset hash for the subset; and
storing, in one or more hash tables, (a) the first identifier in association with the first hash, (b) the second identifier in association with the second hash, and (c) the subset identifier in association with the first subset hash;
wherein the method is performed on at least one device comprising a hardware processor.

2. The method of claim 1, comprising:
accessing a second data set, wherein:
the second data set comprises a second subset of data;
the second subset comprises a third data item and a fourth data item;
the third data item has a third identifier identifying the second data set, the second subset, and the third data item; and
the fourth data item has a fourth identifier identifying the second data set, the second subset, and the fourth data item;
responsive to the third identifier matching the first identifier:
generating a second subset hash for the second subset; and
responsive to the second subset hash differing from the first subset hash:
generating a third hash for the third data item;
generating a fourth hash for the fourth data item;
responsive to the third hash differing from the first hash, updating the first data item with the third data item; and
responsive to the fourth hash matching the second hash, not updating the second data item with the fourth data item.

3. The method of claim 1, wherein:
the data set is a first data set, the identifier is a first identifier, the subset of data is a first subset of data having a second identifier, and the data item is a first data item;
the method further comprising:
accessing a second data set and a third identifier for the second data set, the second data set comprising a second subset of data, the second subset of data having a fourth identifier and including a second data item;
responsive to the first identifier matching the third identifier:
generating a third hash for the second data set;
comparing the first hash to the third hash; and
responsive to the third hash differing from the first hash:
comparing the second identifier to the fourth identifier; and
responsive to the second identifier matching the fourth identifier:
generating a fourth hash for the second subset of data;
comparing the fourth hash to the second hash; and
responsive to the fourth hash differing from the second hash:
indexing the second data item; and
updating the first data item based on the second data item.

4. The method of claim 2, wherein:
the first data item comprises a first document chunk; and
the second data item comprises a second document chunk;
the method further comprising:
updating the first data item by:
overwriting the first document chunk with the second document chunk;
overwriting the first hash with the third hash; and
overwriting the second hash with the fourth hash.

5. The method of claim 1, wherein:
the data set is a first data set;
the identifier is a first identifier;
the hash table is a first hash table; and
the data item is a first document comprising a first document chunk;
the method further comprising;
accessing (1) a second data set including a second document chunk and (2) a second identifier for the second data set;
identifying the first data set based on matching the first identifier to the second identifier;
responsive to a hash value for the second document chunk differing from a respective hash value in the hash table:
processing the second document chunk using a language model; and
storing the second document chunk.

6. The method of claim 5, further comprising:
processing the second document chunk to obtain a processed text by performing, on the second document chunk using the language model, at least one of: topic extraction, key-phrase extraction, and summary generation; and
storing the processed text in association with the second document chunk.

7. The method of claim 1, wherein:
the data set is a first data set;
the method further comprising:
responsive to a first hash value for a first data structure layer of the first data set differing from a second hash value for a corresponding data structure layer of a second data set: comparing a third hash value for a subsequent data structure sublayer of the first data set to a fourth hash value for a corresponding data structure sublayer of the second data set; and
responsive to the third hash value differing from the fourth hash value:
updating the data item.

8. The method of claim 1, wherein:
the data set comprises a plurality of folders including a first folder;
the first folder comprises a plurality of files including a first file;
the first file comprises a plurality of documents including a first document;
the first document comprises a plurality of document chunks including the document chunk;
the first hash is a hash of a selection consisting of: the data set, the first folder, the first file, the first document, and combinations thereof; and
the second hash is a hash of the document chunk.

9. The method of claim 1, wherein:
the data set is a first data set comprising a first plurality of data layers having a first plurality of identifiers;
the method further comprising;
generating a first plurality of data-layer hashes for the first plurality of data layers;
accessing a second data set comprising a second plurality of data layers, the second plurality of data layers having a second plurality of identifiers matching the first plurality of identifiers;
generating a second plurality of data-layer hashes for the second plurality of data layers; and
identifying a change to the data item by:
identifying a plurality of differences between the first plurality of data-layer hashes and the second plurality of data-layer hashes.

10. The method of claim 1, wherein:
the identifier comprises a unique string based on a uniform resource locator (URL) associated with at least one of: the data set, the subset, or the data item.

11. The method of claim 1, wherein:
the identifier is a first identifier;
the method further comprising:
accessing a second identifier for the subset of data;
accessing a third identifier for the data item; and
storing the second identifier and the third identifier in the hash table.

12. The method of claim 1, wherein:
the identifier comprises a URL acting as a key; and
the hash table comprises at least one of: an artifact layer hash, a folder layer hash, a file layer hash, a document layer hash, or a document chunk layer hash.

13. The method of claim 12, further comprising:
storing, in the hash table, a document chunk identifier comprising the URL, a chunk number, a chunk modality, and a chunk type.

14. The method of claim 1, wherein:
the data item comprises a document including at least a document chunk, wherein the document chunk is one of: (1) a content-related text corpus, (2) an image, (3) a cascading style sheet (CSS) definition, (4) a hypertext markup language (HTML) component, or (5) JavaScript (JS) code.

15. The method of claim 13, wherein:
the document chunk is a first document chunk;
the method further comprising:
responsive to a hash of a second document chunk of a second data set indicating a change to the first document chunk by differing from a corresponding hash of the document chunk:
identifying a chunk type of the document chunk;
responsive to a type of the document chunk being content-related, updating the first document chunk based on semantically processing the second document chunk; and
responsive to the type being meta-data related, updating the first document chunk based on the second document chunk without semantically processing the second document chunk.

16. The method of claim 1, further comprising:
identifying a first modality of the data item and first chunk number of the data item;
generating the identifier based on the first modality and the first chunk number;
responsive to identifying the first modality as image-modal:
storing a first encoding of a first image of the data item in the hash table;
responsive to identifying the first modality as text-modal:
performing semantic processing on a first text corpus of the data item to generate processed text;
storing a first text hash of a first text corpus of a document chunk of the data item in the hash table.

17. The method of claim 16, further comprising:
responsive to a second document chunk of a second data set having identification matching to the identifier:
identifying a second modality of the second document chunk; and
responsive to identifying the second modality as image-modal: comparing a second embedding of a second image of the second document chunk to the first embedding; and
responsive to identifying the second modality as text-modal: comparing a second text hash of a second text corpus of the second document chunk to the first text hash.

18. The method of claim 1, wherein:
the data set comprises a first data set; and
the data item comprises a first document chunk;
the method further comprising:
responsive to a second document chunk of a second data set having a matching identifier and a different hash value:
collecting one or more metrics for the first data set, the one or more metrics being selected from: a number of changes to the first document chunk, a density of changes to the first document chunk, a number of document chunks of the data item containing changes, a number of data items for which a system requested edits, a number of changes to a topic extracted from the data item, a number of changes to a summary of the data item, and a number of changes to a key-phrase of the data item; and
responsive to a metric for the data item satisfying a condition:
generating a notification identifying the data item; and
visualizing the data item and the metric in a graphical user interface.

19. One or more non-transitory computer readable media comprising instructions which, when executed by one or more hardware processors, cause performance of operations comprising:
accessing a data set, the data set comprising a subset of data including a first data item and a second data item, the subset having a subset identifier, the first data item having a first identifier identifying (a) the data set, (b) the subset, and (c) the first data item, and the second data item having a second identifier identifying (a) the data set, (b) the subset, and the (c) second data item;
generating a first hash for the first data item;
generating a second hash for the second data item;
generating a first subset hash for the subset; and
storing, in one or more hash tables, (a) the first identifier in association with the first hash, (b) the second identifier in association with the second hash, and (c) the subset identifier in association with the first subset hash.

20. A system comprising:
at least one device including a hardware processor;
the system being configured to perform operations comprising:
accessing a data set, the data set comprising a subset of data including a first data item and a second data item, the subset having a subset identifier, the first data item having a first identifier identifying (a) the data set, (b) the subset, and (c) the first data item, and the second data item having a second identifier identifying (a) the data set, (b) the subset, and the (c) second data item;
generating a first hash for the first data item;
generating a second hash for the second data item;
generating a first subset hash for the subset; and
storing, in one or more hash tables, (a) the first identifier in association with the first hash, (b) the second identifier in association with the second hash, and (c) the subset identifier in association with the first subset hash.
